(19) United States
(12) Patent Application Publication
(10) Pub. No.: US 2009/0094375 A1
(43) Pub. Date: Apr. 9, 2009

(54) Method And System For Presenting An Event Using An Electronic Device

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/867,811

(22) Filed: Oct. 5, 2007

(51) Int. Cl. G06F 15/16

(52) U.S. Cl. 709/231

(57) ABSTRACT

Methods and systems are described for presenting a virtual media object stream of an event via a device where a user of the device is allowed to at least one of view and hear the event virtually from a virtual location in the performance space of the event while the user and the device are physically situated at another location. Location information representing the virtual location in the performance space is received and the virtual media object stream is generated based on raw media object streams associated with at least one of audio and video signals captured in a performance space during the event that include at least one of video content corresponding to a view of the event from a location in the associated region and audio content corresponding to sounds of the event from a location in the associated region in the performance space.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Typically, performance events, such as lectures, musical concerts, and theatrical productions, are presented in rooms, auditoriums, stadiums, or theaters. One or more performers usually perform on a stage and the listening and viewing audience members are usually seated in rows one behind the other or standing in a crowd in a designated audience area in front of and/or around the stage.

In most cases, an audience member's viewing and listening experience will depend largely on where she is sitting (or standing). For example, the audience member's viewing experience can be optimal when she is sitting near the center of the stage and in one of the front rows so that her view is unobstructed. Nonetheless, depending on the acoustic arrangement of the performance space, the audience member's listening experience can be optimal in a row farther away from the stage. Accordingly, optimizing both the audience member's viewing and listening experience simultaneously can be physically impossible.

Moreover, in many performance spaces, seats in the areas offering optimal viewing and/or listening experiences are usually desirable and therefore most costly. Audience members who cannot afford the cost of those desirable seats often sit in areas with an obstructed or partial view and/or a distorted or unbalanced acoustic effect.

Accordingly, there exists a need for methods, systems, and computer program products for presenting an event so that an individual can enjoy the event regardless of his or her physical location.

### SUMMARY

Methods and systems are described for presenting an event. One method includes receiving at least one of a plurality of raw media object streams associated with at least one of audio and video signals captured in a performance space during an event. Each of the received at least one raw media object streams is associated with a region in the performance space of the event and includes at least one of video content that corresponds to a view of the event from a location in the associated region and audio content that corresponds to sounds of the event from a location in the associated region in the performance space. The method also includes receiving location information representing a virtual location in the performance space and generating a virtual media object stream from at least one of the received at least one raw media object streams based on the received location information. The virtual media object stream is associated with a region within which the virtual location is located. The virtual media object stream is provided for presentation on a device, wherein a user of the device is allowed to at least one of view and hear the event virtually from the virtual location while the user and the device are physically situated at a location other than the virtual location.

In another aspect of the subject matter disclosed herein, a system for presenting an event includes means for receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space and means for receiving location information representing a virtual location in the performance space. The system further includes means for generating a virtual media object stream from at least one of the received at least one raw media object streams based on the received location information, wherein the virtual media object stream is associated with a region within which the virtual location is located, and means for providing the virtual media object stream for presentation on a device.

In another aspect of the subject matter disclosed herein, a system for presenting an event includes a virtual location manager component configured for receiving receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space, and a location correlator component configured for receiving and processing location information representing a virtual location in the performance space. The virtual location manager component is configured for generating a virtual media object stream from at least one of the received at least one raw media object streams based on the received location information, wherein the virtual media object stream is associated with a region within which the virtual location is located, and for providing the virtual media object stream for presentation on a device.

In another aspect of the subject matter disclosed herein, a computer readable medium containing a computer program, executable by a machine, for presenting an event includes instructions for receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space, for receiving location information representing a virtual location in the performance space, for generating a virtual media object stream from at least one of the received at least one raw media object streams based on the received location information, wherein the virtual media object stream is associated with a region within which the virtual location is located, and for providing the virtual media object stream for presentation on a device.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1A illustrates a top view of an exemplary performance space in which an event is being presented according to one embodiment;

FIG. 1B is a block diagram illustrating an arrangement for an exemplary event presentation system according to one embodiment;

FIG. 2 is a block diagram illustrating an exemplary event presentation server according to one embodiment;

FIG. 3 is a block diagram illustrating an exemplary client device according to one embodiment;

FIG. 4 is a flowchart illustrating a method for presenting an event according to an exemplary embodiment;

FIG. 5 illustrates an exemplary client device according to one embodiment;

FIG. 6A and FIG. 6b illustrate examples of composite video images from two sets of video cameras according to one embodiment; and

FIG. 7 is a block diagram illustrating an event presentation server and a client device according to another embodiment.

### DETAILED DESCRIPTION

Methods, systems, and computer program products for presenting an event are disclosed. According to one embodiment, an event, such as a concert or theatrical production, is presented via an electronic client device. A user of the client device can view the event on a display provided by the client device and listen to the event through the client device's audio output component, e.g., a headset or built-in speakers. The event can be presented in real time, i.e., contemporaneously, or at a later time. In one embodiment, the client device creates a virtual performance space corresponding to the physical performance space of the event. Using the client device, the user can virtually move from one location to another location in the virtual performance space. As the user navigates virtually within the performance space, the display provides different views of the event based on the user's virtual position. Similarly, the audio stream outputted by the client device's headphones is also based on the user's virtual position such that the sound the user hears is that which would be heard at the virtual position.

For example, suppose the user is attending, actually or virtually, a rock concert and virtually navigates toward a region in the performance space near a lead guitar player. The user's client device can present a view of the lead guitar player, and the audio level of the lead guitar player's guitar would be adjusted louder in the client device's headphones. When the user then virtually navigates across the room, away from the lead guitar player, to another region in the performance space near a piano player, the user's client device would now present a view of the piano player, and the audio level of the piano would be enhanced, while the audio level of the lead guitar player would be diminished.

In an exemplary embodiment, various known audio processing techniques can be applied to the audio stream to further enhance the listening experience for the user. For example, crowd noise can be removed and/or the audio stream can be mixed using spatial audio delay techniques to simulate the spatial audio sound that would accompany the user's location. In another embodiment, the user can select a particular performer, and enhance or eliminate that performer's audio stream independent of the user's virtual location in the virtual performance space.

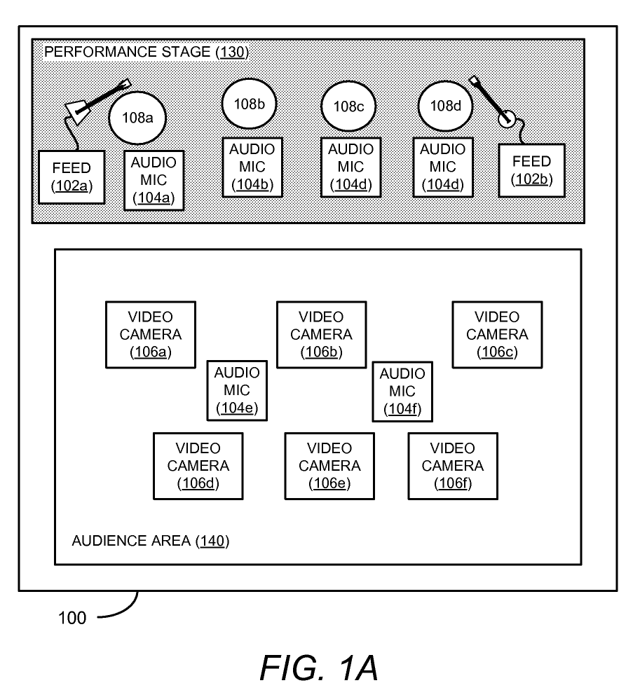

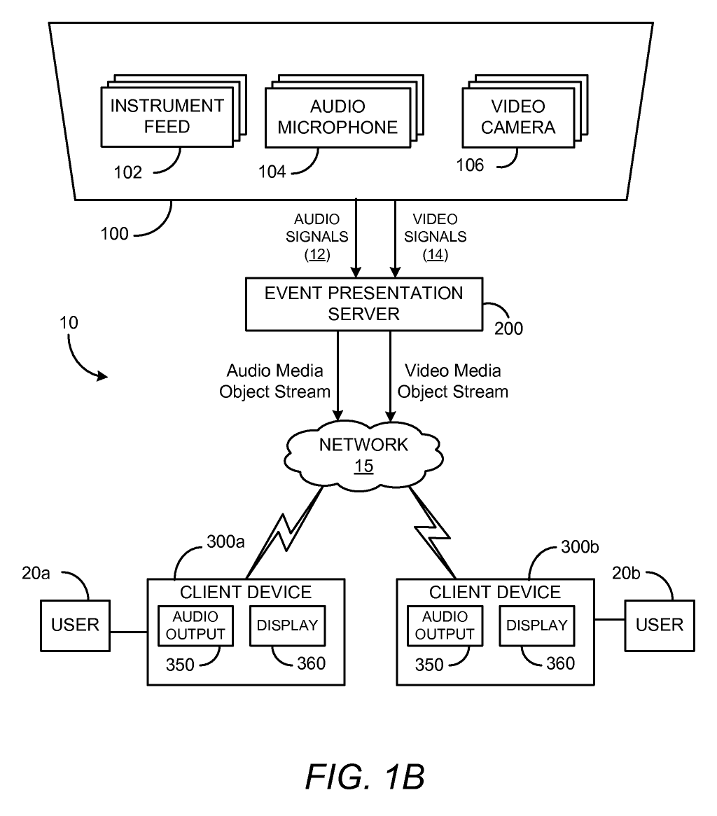

FIG. 1A is a top view of an exemplary performance space in which an event is being presented. The performance space 100 includes a performance stage 130 for a plurality of performers 108a-108d, and an audience area 140 for a plurality of listening and viewing audience members (not shown). In one embodiment, a plurality of audio microphones 104a-140f are located in a plurality of regions in the performance space 100. For example, some audio microphones 104a-104d can be located on the performance stage 130 near the plurality of performers 108a-108d and some audio microphones 104e, 104f can be located in the audience area 140. The microphones 104a-104f capture audio signals from the performers 108a-108d and from the audience area 140. In addition, a plurality of instrument feeds 102a, 102b are directly coupled to a plurality of musical instruments played by the performers, e.g., 108a, 108d, and capture audio signals from the instruments.

According to an exemplary embodiment, a plurality of video cameras 106a-106f are located in a plurality of regions in the performance space 100. Each video camera 106a-106f is focused on a performer 108a-108d, on an area of the stage 130, or on a musical instrument. The video cameras 106a-106f capture video signals of the specific performers 108a-108d, the specific areas of the stage 130, and the specific musical instruments.

FIG. 1B is a block diagram of an arrangement for an exemplary event presentation system according to one embodiment. The system 10 includes an event presentation server 200 configured to receive audio signals 12 captured by the plurality of instrument feeds 102 and the plurality of audio microphones 104 in the performance space 100, and to receive video signals 14 captured by the plurality of video cameras 106 in the performance space 100. One or more network-enabled client devices 300a, 300b, such as a digital camera/phone, PDA, laptop or the like, are in communication with the event presentation server 200 over a network 15 so that users 20a, 20b of the client devices 300a, 300b can view and/or listen to the event being performed in the performance space 100. In one embodiment, a user, e.g., 20a, can be physically in the audience area 140 of the performance space 100 attending the event. In another embodiment, a user, e.g., 20b, can be outside of the performance space 100 and attending the event remotely.

In one embodiment, when the event presentation server 200 receives the audio signals 12 and video signals 14, it is configured to convert the audio signals 12 and video signals 14 into audio and video media object streams, respectively, and to broadcast the audio and/or video media object streams to the client devices 300a, 300b via the network 15. Each client device, e.g., 300a, includes a display component 360 for presenting the received video information to the user 20a, and an audio output component 350 for presenting the received audio information to the user 20a.

According to one exemplary embodiment, a virtual location in the performance space 100 can be selected, e.g., using the client device 300a, and in response to such a selection, the client device 300a can present the view and sounds of the performance from the selected virtual location in the performance space 100. In one embodiment, the video media object streams can be arranged and multiplexed to form a composite video image corresponding to a view of the performance stage 130 from the virtual location. Moreover, the audio media object streams can be mixed, and multi-channel multiplexing techniques can be applied to produce a multi-channel audio stream based on the virtual location in the performance space 100. In this manner, the user 20a can view and hear the event from a virtual front row seat or any other virtual seat in the audience area 140. Another user 20b not able to attend the event can connect, and attend the concert remotely.

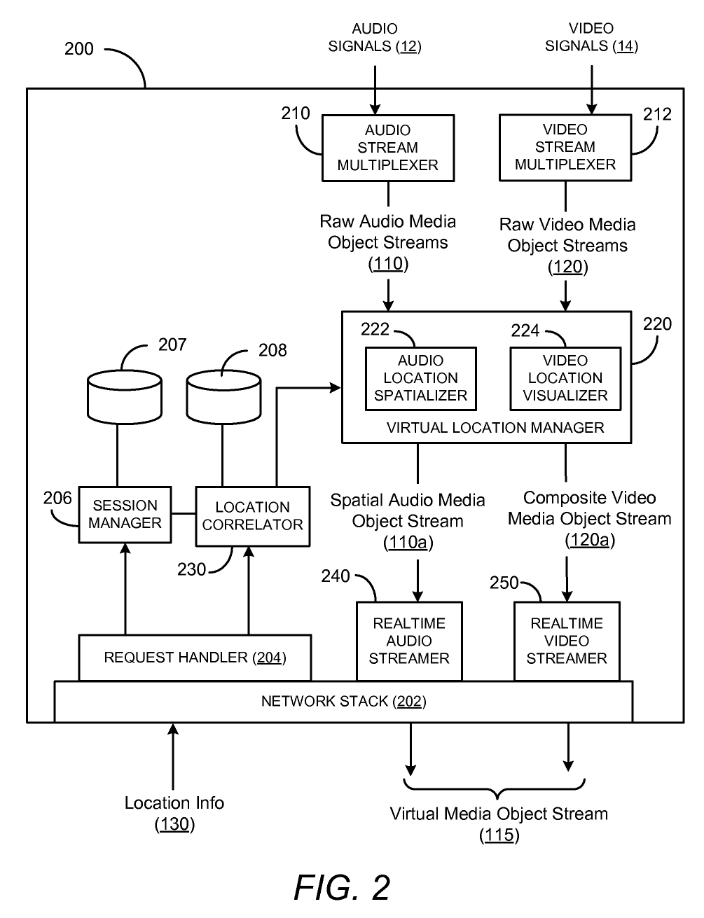

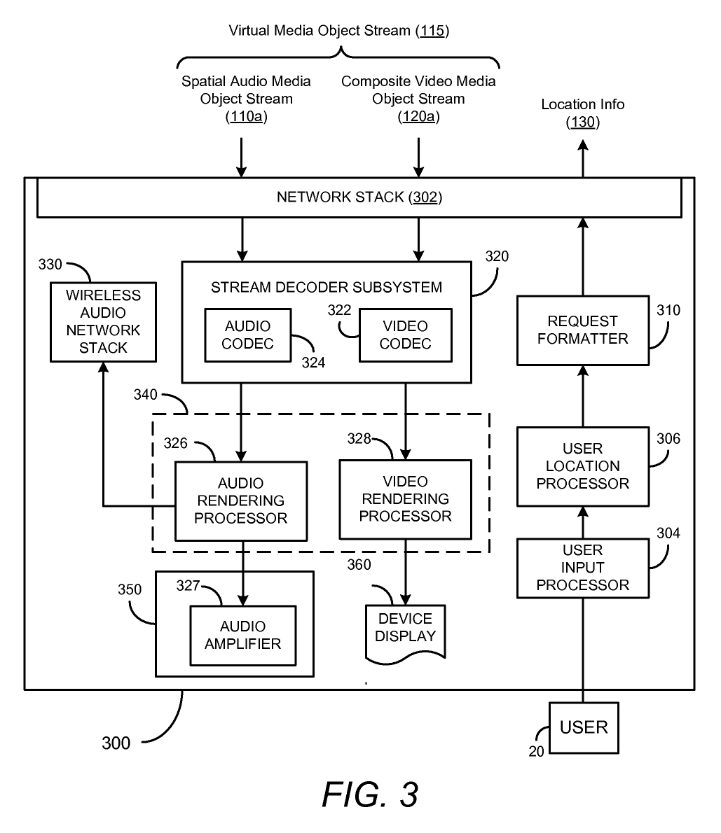

To describe the interoperation between the event presentation server 200 and the client device 300 in more detail, reference to FIG. 2 and FIG. 3 is made. FIG. 2 is a block diagram illustrating an event presentation server 200 according to one embodiment, and FIG. 3 is a block diagram illustrating a client device 300 according to one embodiment. In one embodiment, before the event is presented, a user, e.g., 20, first registers to have the event presented on the client device 300 of FIG. 3. The user 20 can register in a number of ways. For example, the user 20 can register for the event in advance and an event provider can send the user 20 an electronic message with a URL to the event, or other token. In another embodiment, the event provider can provide to the user's device 300 a downloadable application that can be used to present the event to the user 20.

Once registered, the user 20 can establish a session with the event presentation server 200 at the time of the event. In one embodiment, for example, in response to the user's request to login, the device 300 can display a login screen that receives the user's name and an event token for the event. The event token can authorize the user's access to the event and can be provided to the user 20 during registration. In one embodiment, when the user 20 is physically attending the event, the user 20 can provide a row and a seat number corresponding to the user's location in the performance space 100. When the login screen is completed, a login manager (not shown) can send the login request to a request formatter component 310 for processing.

The request formatter 310 can formulate a session setup request to be sent to the event presentation server 200. The session setup request can include the login information collected by the login screen, port assignments for the client device 300 to receive information from the event presentation server 200, and capabilities for the device display component 360 and the audio output component 350. For example, the capabilities can include dimensions of the display device 360 and the frames per second displayed, and the number of channels (mono, stereo, multi-channel) the audio output component 350 can support.

In one embodiment, the session setup request is formatted as an HTTP request, but other network formats could be used including UDP, SOAP and others. The request formatter component 310 forwards the HTTP request to a network stack component 302, which sends the HTTP request to the event presentation server 200 via the network 15. Referring now to FIG. 2, the event presentation server 200 receives the session setup request packet from the client 300 via a network stack component 202. The network stack component 202 can determine that the packet is an HTTP request and can forward the packet to a request handler component 204 for processing. The request handler component 204 extracts information relating to the client device 300 and user 20 from the login information and passes it to a session manager component 206. The session manager component 206 stores the client device 300 and user 20 data in a session database 207. Once the session is established, the event presentation server 200 can collect and send audio and video information to the client device 300 via the ports specified by the device 300.

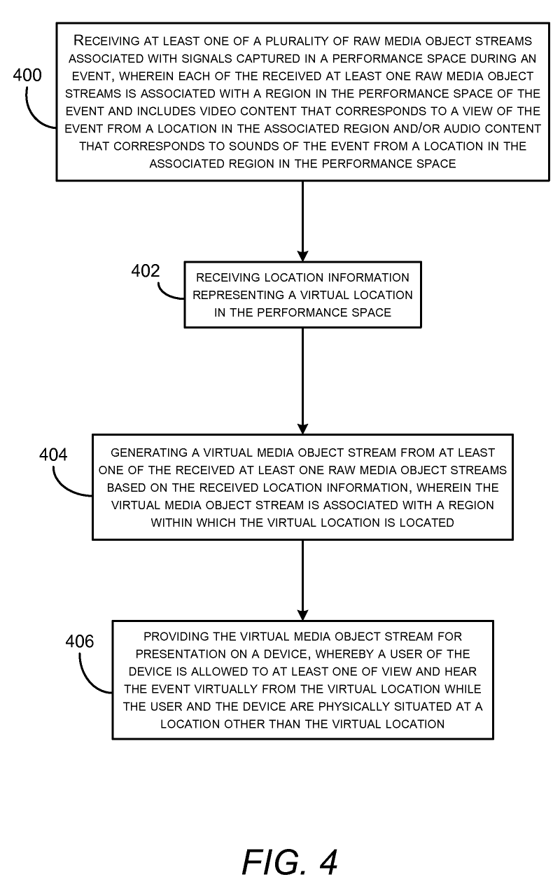

FIG. 4 is a flowchart illustrating an exemplary method for presenting an event according to one embodiment. Referring to FIGS. 1-4, the exemplary method begins when at least one of a plurality of raw media object streams associated with at least one of audio and video signals captured in a performance space during an event is received. In one embodiment, each of the received at least one raw media object streams 110, 120 is associated with a region in the performance space 100 of the event and includes at least one of video content that corresponds to a view of the event from a location in the associated region and audio content that corresponds to sounds of the event from a location in the associated region in the performance space 100 (block 400).

According to an exemplary embodiment, the system 10 includes means for receiving the at least one of a plurality of raw media object streams 110, 120. For example, the event presentation server 200 can include a virtual location manager component 220, shown in FIG. 2, to perform this function. The event presentation server 200, in one embodiment, can receive audio signals 12 captured by the plurality of microphones 104 and instrument feeds 102 via an audio stream multiplexer 210, and the video signals 14 captured by the plurality of video cameras 106 via an video stream multiplexer 212. The audio stream multiplexer 210 converts each electrical audio signal 12 into a discrete raw audio media object stream 110 and encodes it using audio encoders (codecs) that are well known in the art. For example, the audio streams 110 can be encoded using an MP3 codec in one embodiment. Alternative encoding formats include but are not limited to Quicktime, RealMedia, AAC and MP4 formats.

The video stream multiplexer 212 receives and converts each video signal 14 into a discrete raw video media object stream 120. These raw video object streams 120 are encoded using video encoders (codecs) that are well known in the art. For example, the raw video object streams 120 can be encoded using an MPEG-4 codec in one embodiment. Alternative formats include but are not limited to Windows Media, Real Media, Quicktime, and Flash.

Once converted and encoded, the raw audio 110 and video 120 media object streams are passed to the virtual location manager component 220. In one embodiment, the virtual location manager component 220 includes an audio location spatializer component 222 that receives the raw audio media object streams 110, and a video location visualizer component 224 that receives the raw video media object streams 120. The functions of these components 222, 224 will be described more fully below.

Referring again to FIG. 4, the exemplary method continues when location information representing a virtual location in the performance space 100 is received (block 402). According to an exemplary embodiment, the system 10 includes means for receiving the location information representing the virtual location in the performance space 100. For example, the event presentation server 200 can include a location correlator component 230, shown in FIG. 2, to perform this function. In one embodiment, the audience area 140 in the performance space 100 can be defined by a coordinate system that uses a set of coordinates to identify a location for each member of an audience. Thus, the location information, in one embodiment, can include coordinate information comprising a set of coordinates corresponding to the virtual location.

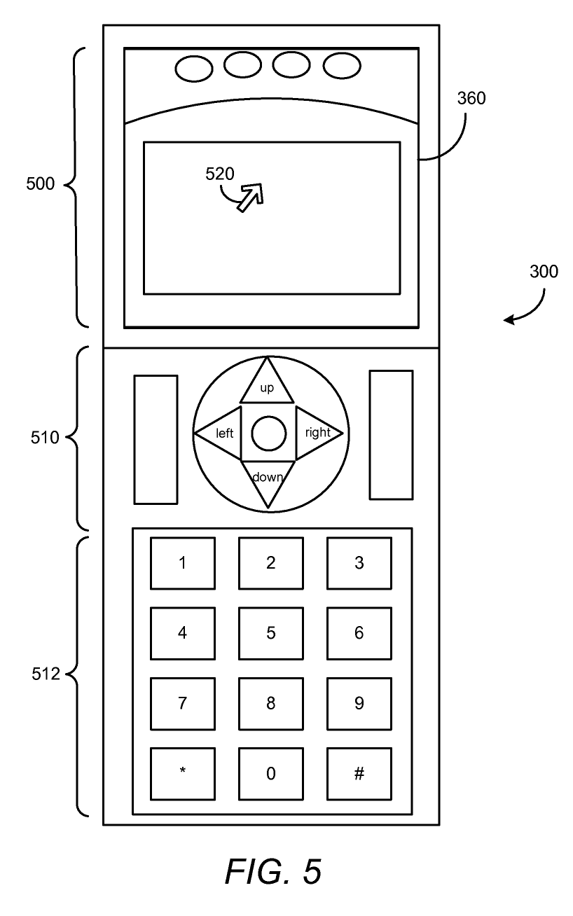

According to one embodiment, the location correlator component 230 receives the location information from the client device 300 via the network 15. For example, referring to FIG. 5, the client device 300 can create a virtual performance space 500 corresponding to the physical performance space 100, and present the virtual performance space 500 on the display device 360. In one embodiment, the user 20 can navigate around the virtual performance space 500 using any of a plurality of navigation keys 510, which move a pointer 520 in the virtual performance space 500. Each location of the pointer 520 can be associated with a set of coordinates that correspond to the coordinate system defining the audience area 140 in the physical performance space 100. Alternatively, or in addition, the user 20 can navigate around the virtual performance space 500 by using an alphanumeric keypad 512 to enter at least one of a row number and a seat number in the virtual performance space 500.

In one embodiment, when the user 20 presses a navigation key 510 or a key in alphanumeric keypad 512, the input is received by a user input processor component 304, shown in FIG. 3, which determines the key pressed and invokes a user location processor component 306 to create a request to update the user's location to the set of coordinates associated with the new location or to the row and/or seat number. For example, referring to FIG. 5, when the user 20 presses an “UP” navigation key 510, the user location processor component 306 can create a request to move the user 20 to a virtual location closer to the performance stage. Similarly, when the user presses a “DOWN” key 510, a request to move the user to a virtual location farther from the performance stage is created, when the user presses a “LEFT” key, a request to move the user to a virtual location to the left of stage is created, and when the user presses a “RIGHT” key, a request to move the user to a virtual location to the right of the stage is created. Using the navigation keys 510, the user 20 can navigate to any position in the linear area in the virtual performance space 500.

Referring again to FIG. 3, once the request to move the user 20 has been created, the user location processor component 306 can call the request formatter 310 to format an HTTP request to update the user's location. In one embodiment, the request includes the location information 130 corresponding to the updated virtual location in the virtual performance space 500. The request formatter 310 passes the request including the location information 130 to the network stack component 302, which sends the request to the event presentation server 200 via the network 15.

Referring again to FIG. 2, when the request including the location information 130 is received by the event presentation server 200 via the network stack component 202, the request handler 204 forwards the request to the location correlator component 230. In one embodiment, when the location information includes a row and/or a seat number, instead of a set of coordinates, the location correlator component 230 can query a location database 208 to determine the set of coordinates corresponding to the received row and/or seat number. The location correlator component 230 can then pass the set of coordinates associated with the virtual location to the virtual location manager component 220.

Referring again to FIG. 4, after the location information representing the virtual location is received, a virtual media object stream 115 from at least one of the received at least one raw media object streams is generated based on the received location information. In one embodiment, the virtual media object stream 115 is associated with a region within which the virtual location is located (block 404). According to one embodiment, the system 10 includes means for generating the virtual media object stream 115 based on the received location information. For example, the virtual location manager component 220 can be configured to perform this function.

As stated above, the virtual location manager component 220 includes, in one embodiment, an audio location spatializer component 222 that receives the raw audio media object streams 110, and a video location visualizer component 224 that receives the raw video media object streams 120. According to one embodiment, the spatializer 222 and the visualizer 224 components can generate the virtual media object stream 115 from at least one of the raw audio 110 and raw video 120 media streams based on the user's virtual location in the performance space 100.

According to one embodiment, the virtual media object stream 115 can include at least one of a spatial audio media object stream 110a and a composite video media object stream 120a. The audio location spatializer component 222, in one embodiment, is configured to process raw audio media object streams 110 to generate the spatial audio media object stream 110a, which represents what a user 20 would hear at the virtual location. According to one embodiment, each of the plurality of audio microphones 104a-104f and each of the plurality of instrument feeds 102a, 102b, shown in FIG. 1B, is associated with a location in the performance space 100. Thus, each audio signal captured by each of the plurality of audio microphones 104a-104f and each of the plurality of instrument feeds 102a, 102b, as well as each resulting raw audio media object stream 110 received by the audio location spatializer component 222 is also associated with a location in the performance space 100.

In one embodiment, the audio location spatializer component 222 can use the received location information to determine a distance between the virtual location and the audio microphones 104a-104f and/or the musical instruments. Based on the determined distance, a relative volume of at least one of the plurality of raw audio media object streams 110 can be calculated. For example, when the virtual location is far to the right of the performance stage 130, the distance between the virtual location and the audio microphones 104a, 104b located on the left side of the stage 130 is greater than the distance between the virtual location and the microphones 104c, 104d located on the right side of the stage 130. Accordingly, the relative volume of the raw audio media objects streams 110 associated with the microphones 104c, 104d located on the right side of the stage 130 will be greater than those audio streams 110 associated with the microphones 104a, 104b located on the left side of the stage 130.

In addition, the audio location spatializer component 222 is configured to generate, in one embodiment, a spatial sound effect based on the determined distance between the virtual location and the audio microphones 104a-104f and/or the musical instruments. For example, the audio location spatializer component 222 can create echo and reverb sound effects to simulate sound signals bouncing off physical structures between a sound source, e.g., a performer 108a, and the virtual location and/or when the sound source is at a distance from the virtual location. In some cases, echo and reverb sound effects can be dispersed between channels of the audio source to simulate a spatial feel to the sound. In one embodiment, as the virtual location moves farther from the performance stage 130, the audio location spatializer component 222 can increase the delayed echo and reverb to give the composite sound a spatial quality.

According to one embodiment, the audio location spatializer component 222 composites or mixes the relative volume and the spatial sound effect to generate the spatial audio media object stream 110a for presentation. The spatial quality of the spatial audio media object stream 110a is dependent on the number of channels that can be delivered to the client device 300 and outputted by the audio output component 350. Table A below shows the capabilities that can be employed to give the sound field a feeling of location and spatial quality when various listening devices are used.

TABLE A

| Listening Device | Mixing Capabilities |
|---|---|
| Monaural Device | Relative Volume proportional to the X |
| | coordinate of the virtual location |
| Stereo Device | Relative Volume that is proportionally |
| | positioned across the stereo channels |
| | in relation to the X coordinate of the |
| | virtual location |
| Multi-Channel Device | Relative Volume that is proportionally |
| | positioned across the front left and |
| | right and rear left and right in relation to |
| | the X and Y coordinates of the virtual |
| | location |

While the audio location spatializer component 222 generates the spatial audio media object stream 110a, the video location visualizer component 224 is configured to process raw video media object streams 120 to generate the composite video media object stream 120a, which represents what a user 20 would see at the virtual location. According to one embodiment, video signals 14 from the plurality of video cameras 106a-106f focused on a plurality of regions of the performance stage 130 are assembled into a composite video stream in the form of a matrix.

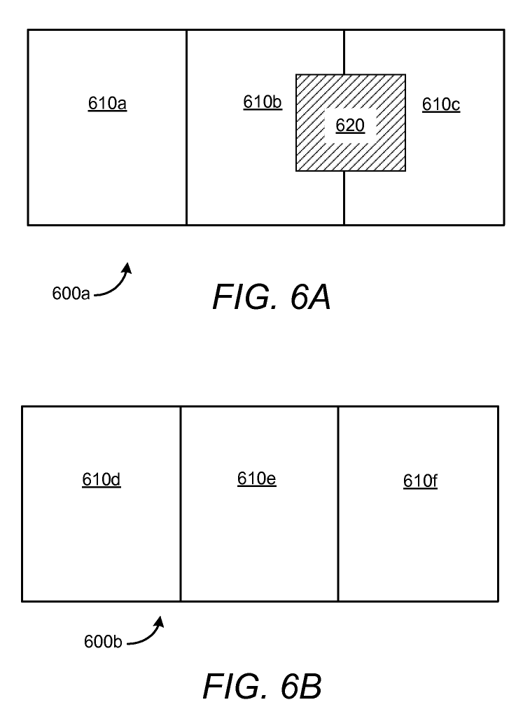

In one embodiment, a performance space 100 can have multiple sets of video cameras 106a-106f located successively farther from the performance stage 130. For example, in one embodiment, a first set of video cameras 106a-106c are located a first distance from the performance stage 130, while a second set of video cameras 106d-106f are located a second distance from the performance stage 130, where the first distance is less than the second distance. FIG. 6A and FIG. 6B illustrate examples of composite video images from the first set of video cameras 106a-106c and the second set of video cameras 106d-106f, respectively. Referring to FIG. 6A, the left most 106a, center 106b, and right most 106c video cameras are aimed, zoomed and focused to capture the video signals 14 producing the left most 610a, center 610b, and right most 610c video images that comprise the composite video image 600a. Similarly, referring to FIG. 6B, the left most 106d, center 106e and right most 106f video cameras are aimed, zoomed and focused to capture the video signals 14 producing the left most 610d, center 610e, and right most 610f video images that comprise the composite video image 600b. Each video image 610a-610f captures a view of the stage 130 area from the audience area 140.

According to an exemplary embodiment, the video location visualizer component 224 is configured to determine a distance between the virtual location and the performance stage 130 and to select at least one raw video media object stream 120 based on the determined distance. The selected raw video media object streams 120 are then composited based on the determined distance to generate the composite video media object stream 120a.

In one embodiment, the selected raw video media object streams 120 are those corresponding to the composite video image 600a, 600b assembled from a set of video cameras immediately in front of the virtual location. For example, when the virtual location is at or behind the second set of video cameras 106d-106f, the selected raw video media object streams 120 are those corresponding to the composite video image 600b assembled from the second set of video cameras 106d-106f. When the virtual location is in front of the second set of video cameras 106d-106f, the selected raw video media object streams 120 are those corresponding to the composite video image 600a assembled from the first set of video cameras 106a-106c. Once the raw video media object streams 120 have been selected, the view from the virtual location can be extracted from the streams by cropping the stream based on the coordinates of the virtual location.

For example, referring to FIG. 6A, a view region 620 of the composite video image stream 600a is selected based on the coordinates corresponding to the virtual location. The view region 620 can be proportioned to match the aspect ratio of the client device's display 360. As the user 20 updates the virtual location, the view region 610 can move to match the current coordinates of the virtual location. The virtual location can move front to back, and side to side, and in some embodiments, the user 20 can pan the performance space 100 up and down. In one embodiment, as the virtual location moves toward the performance stage 130, the view region 620 decreases in size, but is scaled to match the device's display resolution, thereby creating an illusion of zooming in on the performance stage 130 while the focus of the cameras 106a-106f remains constant. The converse of this is also true. In one embodiment, the raw video media object streams 120 corresponding to the view region 620 can be composited to form the composite video media object stream 120a.

The audio mixing and video compositing techniques described above offer but one approach for the assembly of the audio and video streams based on the virtual location in the performance space 100. Other methods and techniques for audio spatialization and video compositing are known to those skilled in the art, and such techniques can be used for the specific benefits and capabilities that they provide.

Referring again to FIG. 4, once the virtual media object stream 115 is generated, it is provided for presentation on the client device 300 wherein the user 20 is allowed to view and/or hear the event virtually from the virtual location while the user 20 and the device 300 are physically situated at a location other than the virtual location (block 406). According to one embodiment, the system 10 includes means for providing the virtual media object stream 115 for presentation on the device 300. For example, the audio location spatializer component 222 and the video location visualizer component 224 in the virtual location manager component 220 can be configured to perform this function.

According to one embodiment, the virtual media object stream 115 can be adjusted to conform to the capabilities of the receiving client device 300. For example, the video location visualizer component 224 can adjust the composite video media object streams 120a to conform to the display capabilities of the device 300 and the audio location spatializer component 222 can modify the spatial audio media object streams 110a to conform to the audio output capabilities. Once adjusted, the virtual media object stream 115 comprising at least one of the spatial audio media object streams 110a and the composite video media object streams 120a can be formatted by a real time audio streamer component 240 and a real time video streamer component 250, respectively, for transmission to the client device 300 over the network 15 via the network stack component 202.

Referring again to FIG. 3, the client device 300 receives the virtual media object stream 115 via the network stack component 302, which forwards the stream to a stream decoder component 320 for decoding. The stream decoder component 320 includes a video codec component 322 for decoding the composite video media object stream 120a, and an audio codec component 324 for decoding the spatial audio media object stream 110a. The stream decoder component 320 forwards the decoded virtual media object stream 115 to a media rendering component 340 that includes an audio rendering processor component 326 and a video rendering processor component 328.

In one embodiment, the audio rendering processor component 326 converts the decoded spatial audio media object stream 110a into an electrical audio signal, which is then forwarded to the audio output component 350. The audio output component 350 can include an audio amplifier component 327 for amplification and presentation to the user 20 via a speaker (not shown) or headphones.

Alternatively or additionally, the output of the audio rendering processor component 326 can be sent to a wireless audio network stack component 330 for wireless transmission to a set of wireless headphones or other listening device. The wireless audio network stack component 330 can be implemented as a Bluetooth device stack such that a wide range of monaural and stereo Bluetooth headphones can be used. Other types of network stacks may include Wi-Fi stacks and stacks that implement public and proprietary wireless technologies.

In one embodiment, the video rendering processor component 328 can convert the decoded composite video media object stream 120a into a plurality of video frames. The video rendering processor component 328 sends the video frames to the display 360 for presentation to the user 20.

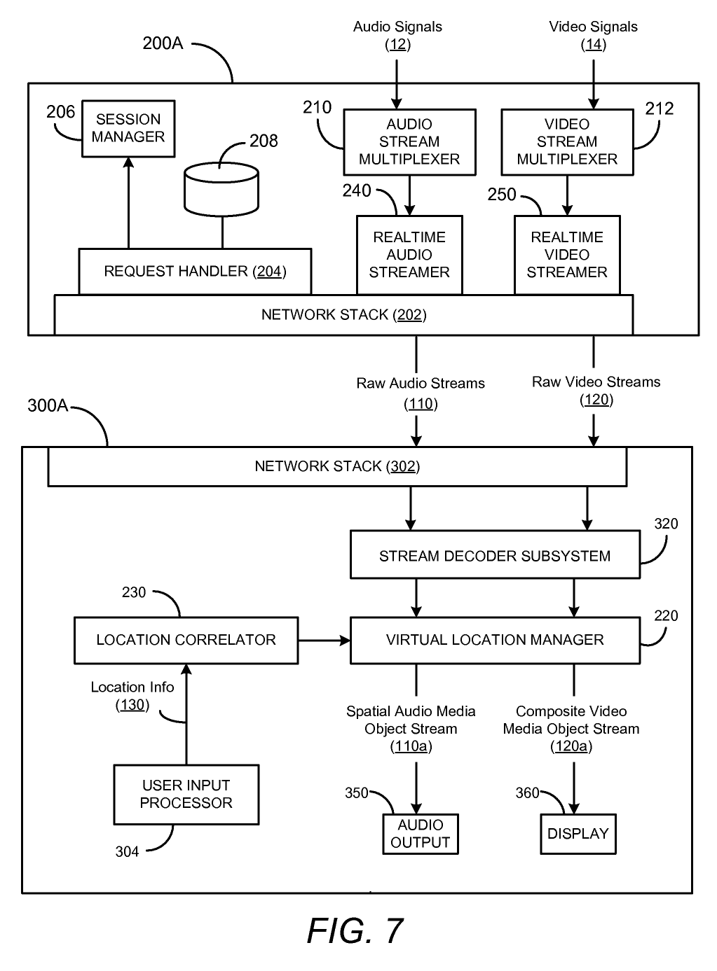

The system 10 illustrated in FIG. 1B, FIG. 2 and FIG. 3 is but one exemplary arrangement. In this arrangement, a “thin” client device 300 can be accommodated because the functionality of the virtual location manager component 220 and the location correlator component 230 can be included in the event presentation server 200. Other arrangements can be designed by those skilled in the art. For example, in one embodiment, shown in FIG. 7, the client device 300A can perform the functions of the virtual location manager component 220 and the location correlator component 230.

In this arrangement, the event presentation server 200A sends the encoded raw audio 110 and video 120 streams to the client device 300A and the client device 300A performs the video and audio signal processing functions to produce the composite video 120a and spatial audio 110a streams that represent the view and sound at the virtual location in the performance space 100. In one embodiment, the location database 208 can remain on the event presentation server 200A so that a plurality of client devices may query the virtual location based on seat and row number information.

According to one embodiment, the client device 300A receives and decodes the raw audio 110 and video 120 streams, which are then passed to the virtual location manager component 220. The user can provide location information corresponding to a virtual location in the virtual performance space, as described above. The location information 130 is received by the user input processor 304 and passed to the virtual location manager component 220 via the location correlator component 230. The virtual location manager component 220 assembles the spatial audio 110a and composite video 120a streams based on the raw audio 110 and raw video 120 streams received from the event presentation server 200A, as described above.

In this arrangement, the event presentation server 200A broadcasts the same raw audio and video streams to all client devices. In one embodiment, the client device 300A can be configured to request and receive a portion of the raw video media object streams 120 based on the virtual location. For example, the client device 300A can request only the video streams associated with the field of view corresponding to the virtual location.

Variations of these embodiments may be utilized and structural and functional modifications may be made without departing from the scope of the present disclosure. For example, in one embodiment, specific raw audio media object streams 110 associated with a specific sound source, e.g., a specific performer 108a, or with a specific musical instrument can be selectively enhanced and/or eliminated. In this embodiment, the audio location spatializer 222 can receive an indication identifying the sound source, e.g., performer 108a, or the musical instrument, e.g., the guitar, and determine the audio microphone 104a or the instrument feed 102a used to capture the audio signal of the identified sound source 108a or musical instrument. Once the audio microphone 104a or instrument feed 102a is identified, the raw audio media object streams 110 associated with the audio signals captured by the identified audio microphone 104a or instrument feed 102a can be processed based on the indication.

In one embodiment, the indication can be to enhance, e.g., increase volume, add modulation, and/or add distortion, the raw audio stream 110. For example, audio sound effects such as distortion and doubler can be applied to the audio stream associated with a guitar, while chorus or doubler sound effects can be applied to the audio stream associated with a performer 108a. In another embodiment, the indication can be to eliminate an enhancement the performer 108a or instrument has added. For example, the performer 108a can enhance his or her voice by applying a “chorus” sound effect. The user can choose to eliminate the “chorus” effect from the raw audio stream 110 in order to hear the performer's voice without enhancement. In another embodiment, the indication can be to eliminate the audio streams 110 from the identified sound source 108a or musical instrument altogether. In one embodiment, as the user adjusts each performer's audio sound characteristics, the raw audio streams 110 are updated in real time so the user can hear the customizations they have applied, as they are selected. It is contemplated that the indication can be to provide any audio enhancements known in this art or to eliminate enhancement aspects of the audio

In a similar manner, specific raw video media objects streams 120 associated with a specific performer 108a, with a specific area of the stage 130, or with a specific musical instrument can be selected for presentation. In this embodiment, the visual location visualizer component 224 can receive an indication identifying the performer 108a, the area of the stage 130 or the musical instrument, e.g., the guitar, and can determine the video camera, e.g., 106a, that is focused on the identified performer 108a, area of the stage 130 or the musical instrument. Once the video camera 106a is identified, the raw video media object streams 110 associated with the video signals captured by the video camera 106a can be processed and presented.

According to another embodiment, a user 20a can identify another user 20b who is also attending the event, and share the viewing and listening experience with the other user 20b. For example, using the event presentation server 200, a first user 20a can identify a second user 20b and the second user's location in the performance space 100. During the performance, the first user 20a can select the second user's location as a virtual location and experience the event from the second user's location.

In another embodiment, the first and second users 20a, 20b can join together. While joined, the users 20a, 20b can each navigate individually while sharing a common single virtual location. Accordingly, as the first user 20a sends a virtual location change, the second user 20b also receives the new location. While the users 20a, 20b are joined they can also audio chat and their conversation can be overlaid on the performance audio optionally lowering the volume of the performance audio when chat audio is being received.

Through aspects of the embodiments described, a user of a client device 300 can view an event on a display provided by the client device 300 and listen to the event through the client device's audio output component, e.g., a headset or built-in speakers. Using the client device 300, the user 20 can virtually move from one location to another location in a virtual performance space corresponding to the physical performance space 100. As the user navigates virtually within the performance space, the display provides different views of the event based on the user's virtual location. Similarly, the audio stream outputted by the client device's headphones is also based on the user's virtual location such that the sound the user hears is that which would be heard at the virtual location. It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for presenting an event, the method comprising:
receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space;
receiving location information representing a virtual location in the performance space;
generating a virtual media object stream from at least one of the received at least one raw media object streams based on the received location information, wherein the virtual media object stream is associated with a region within which the virtual location is located; and
providing the virtual media object stream for presentation on a device, wherein a user of the device is allowed to at least one of view and hear the event virtually from the virtual location while the user and the device are physically situated at a location other than the virtual location.

2. The method of claim 1 wherein the performance space includes an audience area comprising a coordinate system for identifying locations for each member of an audience and wherein receiving location information includes receiving coordinate information corresponding to the virtual location in the performance space.

3. The method of claim 1 further comprising:
capturing a plurality of audio signals via at least one of a plurality of audio microphones located in a plurality of regions in the performance space, and a plurality of instrument feeds directly coupled to a plurality of musical instruments; and
converting the plurality of audio signals into a plurality of raw audio media object streams.

4. The method of claim 3 wherein generating the virtual media object stream comprises:
determining a distance between the virtual location and at least one of the plurality of audio microphones and the plurality of instruments;
calculating a relative volume of at least one of the plurality of raw audio media object streams based on the determined distance;
generating a spatial sound effect based on the determined distance between the virtual location and at least one of the plurality of audio microphones and the plurality of instruments; and
compositing the relative volume and the spatial sound effect to generate a spatial audio media object stream for presentation.

5. The method of claim 3 wherein generating the virtual media object stream comprises:
receiving an indication identifying one of a sound source and a musical instrument;
determining one of an audio microphone and an instrument feed used to capture the audio signal of the identified sound source or musical instrument; and
processing the raw audio media object stream associated with the audio signal captured by the determined audio microphone or instrument feed based on the indication.

6. The method of claim 5 wherein the indication identifies at least one audio enhancement and processing the raw audio media object stream associated with the audio signal includes one of removing or applying the audio enhancement.

7. The method of claim 1 further comprising:
capturing a plurality of video signals via a plurality of video cameras located in a plurality of regions in the performance space, wherein each of the plurality of video cameras is focused on one of a specified performer, a specified area of a stage in the performance space, and a specified musical instrument; and
converting the plurality of video signals into a plurality of raw video media object streams.

8. The method of claim 7 wherein generating the virtual media object stream comprises:
determining a distance between the virtual location and the stage;
selecting at least one raw video media object stream based on the determined distance between the virtual location and the stage; and
compositing the at least one selected raw video media object stream based on the determined distance between the virtual location and the stage.

9. The method of claim 8 wherein providing the virtual media object stream for presentation on the device comprises adjusting the composited video media object stream to conform to display capabilities of the device.

10. The method of claim 7 wherein generating the virtual media object stream comprises:
receiving an indication identifying one of a specified performer, a specified area of the stage in the performance space, and a specified musical instrument;
determining a camera focused on the identified one of specified performer, specified area of the stage in the performance space, and specified musical instrument; and
processing the raw video media object stream associated with the video signals captured by the determined camera.

11. A system for presenting an event, the system comprising:
means for receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space;
means for receiving location information representing a virtual location in the performance space;
means for generating a virtual media object stream from at least one of the received at least one raw media object streams based on the received location information, wherein the virtual media object stream is associated with a region within which the virtual location is located; and
means for providing the virtual media object stream for presentation on a device, wherein a user of the device is allowed to at least one of view and hear the event virtually from the virtual location while the user and the device are physically situated at a location other than the virtual location.

12. A system for presenting an event, the system comprising:
a virtual location manager component configured for receiving receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space; and
a location correlator component configured for receiving and processing location information representing a virtual location in the performance space;
wherein the virtual location manager component is configured for generating a virtual media object stream from at least one of the received at least one raw media object streams based on the received location information, wherein the virtual media object stream is associated with a region within which the virtual location is located, and for providing the virtual media object stream for presentation on a device, wherein a user of the device is allowed to at least one of view and hear the event virtually from the virtual location while the user and the device are physically situated at a location other than the virtual location.

13. The system of claim 12 wherein the performance space includes an audience area comprising a coordinate system for identifying locations for each member of an audience and wherein the location correlator component is configured for receiving coordinate information corresponding to the virtual location in the performance space.

14. The system of claim 12 further comprising at least one of a plurality of audio microphones located in a plurality of regions in the performance space and a plurality of instrument feeds directly coupled to a plurality of musical instruments, each configured for capturing a plurality of audio signals that are converted into a plurality of raw audio media object streams.

15. The system of claim 14 wherein the virtual location manager component includes an audio location spatializer configured for determining a distance between the virtual location and at least one of the plurality of audio microphones and the plurality of instruments, for calculating a relative volume of at least one of the plurality of raw audio media object streams based on the determined distance, for generating a spatial sound effect based on the determined distance between the virtual location and at least one of the plurality of audio microphones and the plurality of instruments, and for compositing the relative volume and the spatial sound effect to generate a spatial audio media object stream for presentation.

16. The system of claim 15 wherein the virtual location manager component includes an audio location spatializer configured for receiving an indication identifying one of a sound source and a musical instrument, for determining one of an audio microphone and an instrument feed used to capture the audio signal of the identified sound source or musical instrument, and for processing the raw audio media object stream associated with the audio signal captured by the determined audio microphone or instrument feed based on the indication.

17. The system of claim 16 wherein the indication identifies at least one audio enhancement and processing the raw audio media object stream associated with the audio signal includes one of removing or applying the audio enhancement.

18. The system of claim 12 further comprising a plurality of video cameras located in a plurality of regions in the performance space, wherein each of the plurality of video cameras is configured for capturing a video signal of one of a specified performer, a specified area of a stage in the performance space, and a specified musical instrument, wherein the video signal is converted into a raw video media object stream.

19. The system of claim 18 wherein the virtual location manager component includes a video location visualizer component configured for determining a distance between the virtual location and the stage, for selecting at least one raw video media object stream based on the determined distance between the virtual location and the stage, and for compositing the at least one selected raw video media object stream based on the determined distance between the virtual location and the stage.

20. The system of claim 19 wherein the video location visualizer component is configured for adjusting the composited video media object stream to conform to display capabilities of the device.

21. The system of claim 18 wherein the virtual location manager component includes a video location visualizer component configured for receiving an indication identifying one of a specified performer, a specified area of the stage in the performance space, and a specified musical instrument, for determining a camera focused on the identified one of specified performer, specified area of the stage in the performance space, and specified musical instrument, and for processing the raw video media object stream associated with the video signal captured by the determined camera.

22. The system of claim 12 further comprising:
an audio stream multiplexer and a video stream multiplexer configured for converting and encoding a plurality of audio signals into a plurality of discrete raw audio streams and for converting and encoding a plurality of video signals into a plurality of discrete raw video streams, wherein the discrete raw audio streams and the discrete raw video streams are received by the virtual location manager component; and
a network stack component configured for transmitting the virtual media object stream to the device via a network.

23. The system of claim 12 further comprising:
a network stack component configured for receiving encoded raw video and raw audio streams associated with video and audio signals captured in the performance space during the event;
a stream decoder component configured for decoding the raw video and raw audio streams, wherein the decoded raw video and raw audio streams are received by the virtual location manager component; and
a media rendering component configured for converting the virtual media object stream into at least one of an electrical audio signal and a plurality of video frames, wherein the electrical audio signal is amplified and presented to the user via speakers and the plurality of video frames is presented to the user via a display.

24. The system of claim 23 further comprising a wireless audio network stack configured for receiving the electrical audio signal and wirelessly transmitting the audio signal to at least one wireless listening device.

25. A computer readable medium containing a computer program, executable by a machine, for presenting an event, the computer program comprising executable instructions for:
receiving at least one of a plurality of raw media object streams associated with at least one of audio and video signals captured in a performance space during an event, wherein each of the received at least one raw media object streams is associated with a region in the performance space of the event and includes at least one of video content that corresponds to a view of the event from a location in the associated region and audio content that corresponds to sounds of the event from a location in the associated region in the performance space;
receiving location information representing a virtual location in the performance space;
generating a virtual media object stream from at least one of the received at least one raw media object streams based on the received location information, wherein the virtual media object stream is associated with a region within which the virtual location is located; and
providing the virtual media object stream for presentation on a device, wherein a user of the device is allowed to at least one of view and hear the event virtually from the virtual location while the user and the device are physically situated at a location other than the virtual location.
